(19) United States
(12) Patent Application Publication
(10) Pub. No.: US 2011/0119589 A1
(43) Pub. Date: May 19, 2011

(54) Navigable User Interface for Electronic Handset

(75) Inventors: Rachid M. Alameh, Crystal Lake, IL (US); Thomas Y. Merrell, Beach Park, IL (US); Hishashi D. Watanabe, Lake Forest, IL (US)

(73) Assignee: MOTOROLA, INC., Schaumburg, IL (US)

(21) Appl. No.: 12/622,157

(22) Filed: Nov. 19, 2009

(51) Int. Cl. G06F 3/16; G06F 3/14

(52) U.S. Cl. 715/727; 715/864; 455/566

(57) ABSTRACT

An electronic device having a user interface on which selectable operation indicators are navigated wherein each operational indicator is associated with a corresponding application or other selectable item. The operational indicators are sequentially identified, in a specified order and for a specified time interval, in response to a first input at the user interface. Selection occurs in response to a second input at the user interface during the corresponding time interval. Such selection may, for example, launch an application or cause the display of a submenu or perform some other function

### FIELD OF THE DISCLOSURE

The present disclosure relates generally to portable electronic devices and, more particularly, to navigable user interfaces for and in electronic devices, for example, in wireless communication handsets, and corresponding methods.

### BACKGROUND

It is known for an electronic device to provide a user interface on a display screen from which a user may activate, initiate or launch various functions, modes of operation, applications, etc. The user interface typically includes an introductory interface, sometimes referred to as a “main menu” or “home screen”, that includes a set of user selectable items or options. The item may correspond to submenus with additional items or the item may correspond to an application, alterable settings, lists, informational content, such as lists of address entries, e-mail messages, web pages and the like. It is also known to navigate items on a graphical user interface using a graphical navigation element like a cursor or a visual highlighting feature. Activation of an input mechanism, such as a thumb wheel, may be used to change the position of the graphical navigation element within the graphical user interface. In many devices, however, navigation is made difficult by the size and/or organization of the user interface and in some devices navigation is complicated by the user input mechanism.

The various aspects, features and advantages of the invention will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 is a schematic diagram of an electronic device.

FIG. 2 is a flowchart depicting navigation of a user interface.

FIG. 3 depicts a display arrangement of a user interface.

FIG. 4 depicts a display arrangement of a user interface.

FIG. 5 depicts a display arrangement of a user interface.

FIG. 6 is a flowchart depicting navigation of a visual interface.

FIG. 7 is a flowchart depicting navigation of a audible interface.

### DETAILED DESCRIPTION

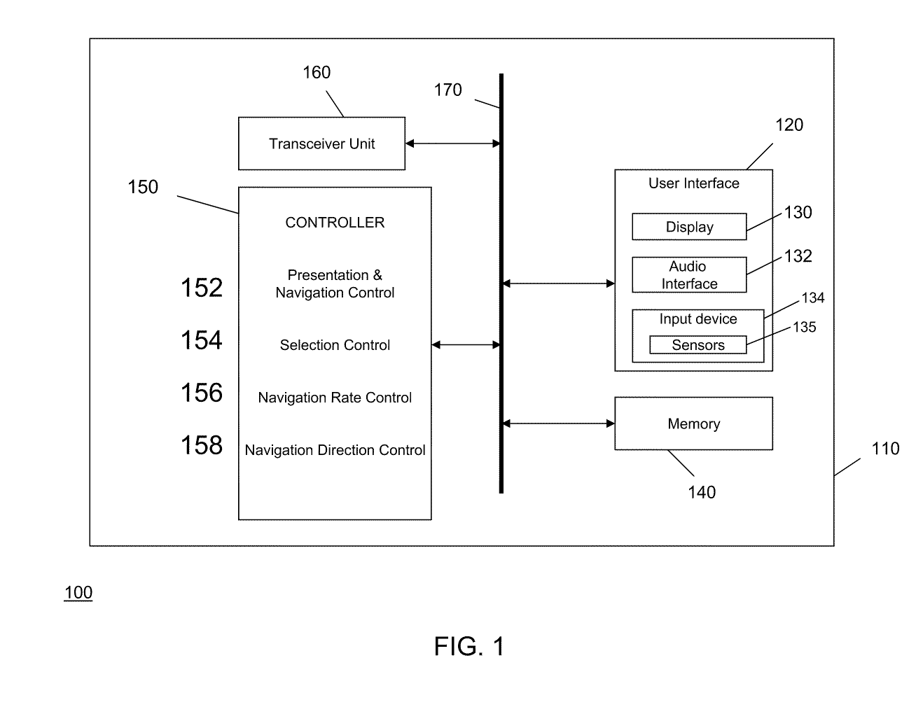

In FIG. 1, an electronic device 100 comprises generally a controller 150 communicably coupled to a user interface 120 on or from which operational indicators may be presented to the user, and navigated and selected by the user. The user interface 120 may be implemented as either a visual display or as an audio output or as a combination thereof as described further below. The electronic device may be embodied as a wireless communication device (such as a cellular telephone), personal digital assistant (PDA), handheld computing device, portable multimedia player, head worn devices, headset type devices, computer screen, gaming device, kiosk, television, and the like. In other implementations, the electronic device is integrated with a larger system, for example, an appliance or a point-of-sale station or some other consumer, commercial or industrial system. One skilled in the art will recognize that the techniques described herein are generally applicable to any environment where a navigable user interface is implemented or desired. More particular implementations are described below.

In one embodiment, the controller is embodied as a programmable processor or as a digital signal processor (DSP) or as a combination thereof. In FIG. 1, the controller 150 is coupled to memory 140 via a bidirectional system bus 170 that enables reading from and writing to memory. The memory 140 may be embodied as Flash memory, a hard disk, a multimedia card, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, an optical disk, and the like.

In the exemplary embodiment of FIG. 1, the controller 150 executes firmware or software or other instructions stored in memory wherein the instructions enable the operation of some functionality of the electronic device 100 depending on the particular implementation thereof. The memory 140 may also store data (e.g., a phonebook, messages, still images, video, etc.) inputted or transferred to or generated on the electronic device. In programmable processor implementations, the memory 140 also stores user interface control and operating instructions that enables the presentation of information on or at the user interface 120 and that enables the navigation of information presented as described more fully below.

In some embodiments including a programmable processor, the electronic device includes an operating system that hosts software applications and other functional code. In wireless communication implementations, for example, the operating system could be embodied as ANDROID™, SYMBIAN®, WINDOWS MOBILE®, or some other proprietary or non-proprietary operating system. In other electronic devices, some other operating system may be used. More generally, however, the electronic device need not include an operating system. In some embodiments the functionality or operation of the electronic device is controlled by embedded software or firmware. In other embodiments the functionality is implemented by hardware equivalent circuits or a combination thereof. The particular architecture of the operating system and the process of executing programs that control the functionality or operation of the device are not intended to limit the disclosure. The enablement of the functionality of electronic devices is known generally by those of ordinary skill in the art and is not discussed further herein.

In FIG. 1, the user interface 120 includes a display device 130 on which a graphical user interface is implemented in at least some embodiments. The user interface 120 includes an audio interface 132 comprising an audio transducer that produces sound perceptible by the user. The user interface 120 also includes an input device 134 having one or more controls. Such an input device 134 may be embodied as a hard or soft key or button, thumbwheel, trackball, keypad, dome switch, touch pad or screen, jog-wheel or switch, microphone and the like, including combinations thereof. The input device 134 receives user inputs and translates the received inputs into control signals using suitable sensors 135 appropriate for the particular input implementation. The input signals are communicated to the controller 150 over the system bus 170 for interpretation and execution based on the operating instructions.

In one implementation, the electronic device 100 of FIG. 1 is embodied as a portable wireless communication device comprising one or more wireless transceivers 160. In other embodiments, the electronic device includes only a receiver or only a transmitter. The transceiver may be a cellular transceiver, a WAN or LAN transceiver, a personal space transceiver e.g., Bluetooth transceiver, a satellite transceiver, or some other wireless transceiver, or a combination of two or more transceivers. In other implementations, the wireless communication device is capable of only receiving or only transmitting, but not both transmitting and receiving. For example, the device may be embodied in whole or in part as a navigation device that only receives navigation signals from a terrestrial source or from space vehicles or a combination thereof. Generally, the electronic device may include multiple transceivers or combinations of transmitters and receivers. For example, the device may include a communication transceiver and a satellite navigation receiver. In other implementations, neither a receiver nor a transmitter constitutes a part of the device. The operation of the one or more transmitters or receivers is generally controlled by a controller, for example, the controller 150 in FIG. 1.

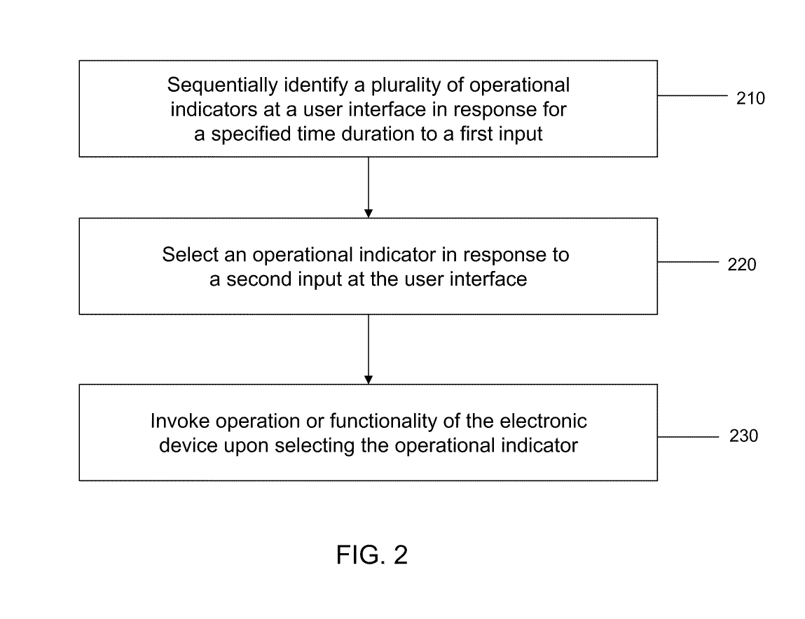

In one embodiment, one or more operational indicators are presented at the user interface of the electronic device. Generally, the controller is configured to navigate multiple operational indicators presented at the user interface in response to a command or input. Navigation occurs by sequentially identifying the operational indicators in some specified order and for some specified time duration as discussed further below. In FIG. 2, at 210, operational indicators are sequentially identified at a user interface of the device in response to a first input. In FIG. 1, the navigation mode, i.e., identification of the operational indicators, is invoked or prompted in response to an input at the input device as detected by one of the sensors 135. The navigation mode may also be terminated by a user prompt as discussed below.

The operational indicators may be embodied as visual cues or as audible cues depending on the type of user interface on which the operational indicators are presented and identified or navigated. The operational indicators are generally associated with various corresponding user selectable items of the electronic device. Such items include menus, applications, contacts, emails, URL links, messages, media files, device mode settings, etc. There is usually a one-to-one correspondence between each operational indicator and the corresponding item with which it is associated. In some embodiments, however, the associated item may comprise several other items. In hierarchical menus structures, for example, a menu item may link to another layer of menu items. In other instances, an item associated with an operational indicator may link to several selectable device settings or other selectable features.

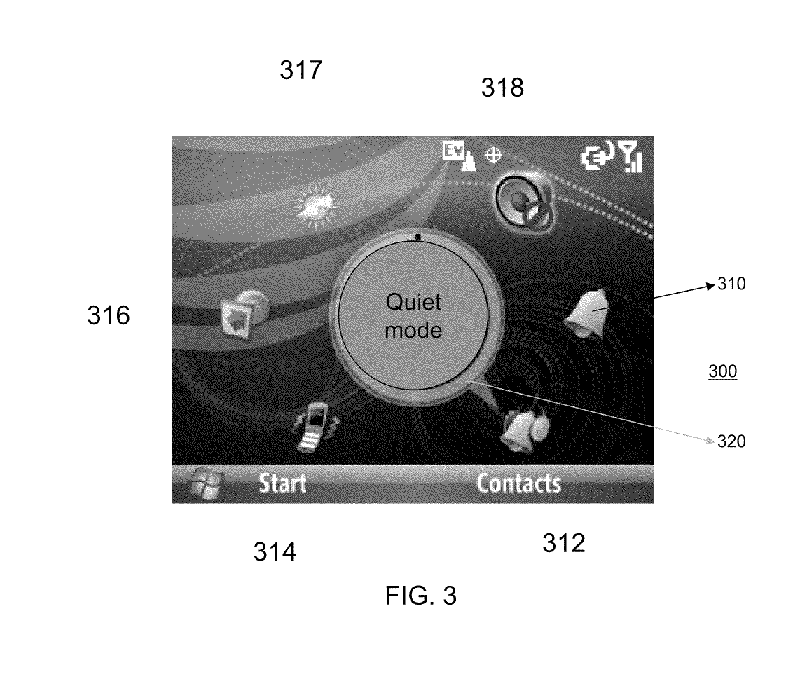

In one embodiment, the visual cue is a visual icon associated with an application or other item that may be launched or initiated upon selection of the operational indicator as discussed further below. The visual cue may be embodied as graphical or textual images or a combination thereof. In FIG. 3, for example, operational indicators corresponding to icons 310, 312, 314, 316, 317 and 318 are presented on the display 300. The icons are associated with settings or applications or some other selectable feature of the device. For instance, the icon 318 corresponds to an audio mode of the device.

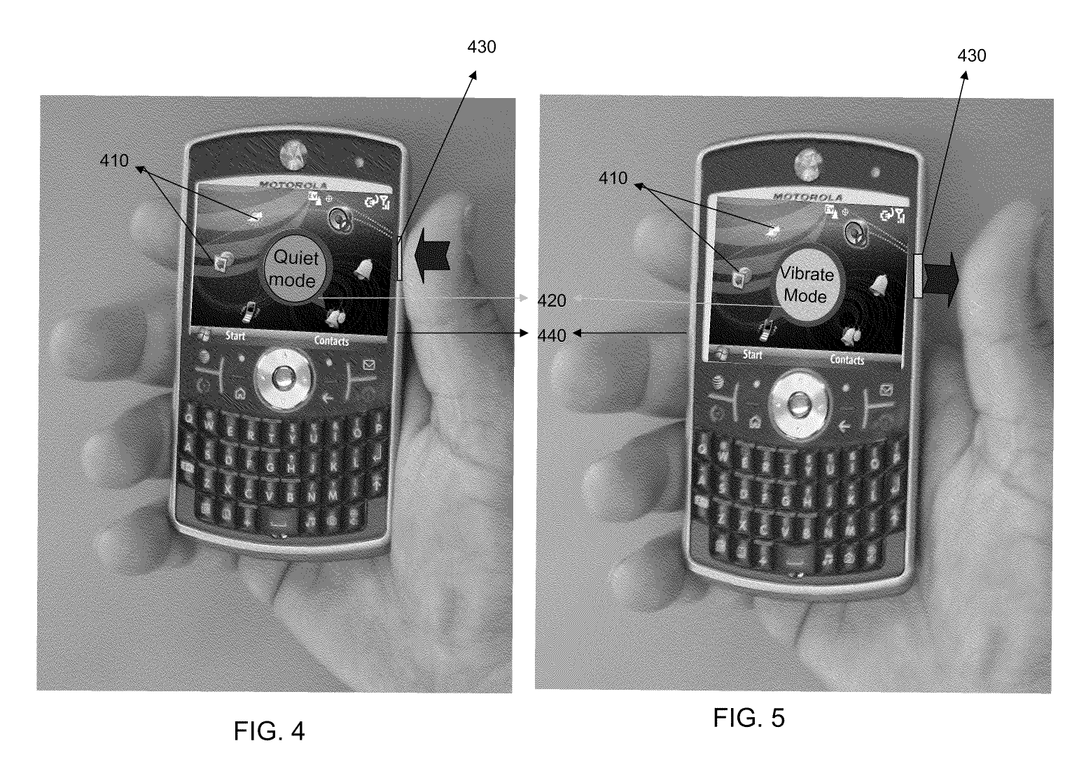

In FIG. 4, multiple icons 410 are navigated when the user presses and holds a push button 430. Navigation refers to the sequential identification of each icon in a specified order for a specified time interval, wherein an icon may be selected during the specified time interval during which it is identified to invoke some functionality associated with the icon. The specified time interval may be constant or it may be variable. In one embodiment, the specified time interval is in a range between a few seconds and a fraction of a second, depending on the ability of the user to perceive the navigation and the rate at which the user desires the navigation to occur. In some embodiments, the user may select and/or change the rate at which navigation occurs. The rate is fixed at some default value. In another embodiment, the navigation proceeds quickly between visual cues and then slows at the indicator approaches each cue, thereby allowing the user time to make a selection if desired. The navigation rate may also be varied by the user as discussed further below.

In FIG. 4, the icon indicator 420 identifies a “quiet mode” icon for a specified duration. At some later time during the navigation process, the icon pointer 420 identifies another icon. In FIG. 5, for example, the icon indicator identifies the “vibrate mode” icon. The process of sequentially identifying the visual icons continues while in the navigation mode until the navigation process is terminated. In one embodiment, the navigation mode is invoked upon depressing the push button 430 and the navigation mode is maintained or continued as long as the push button is depressed. According to this embodiment, when the user ceases to hold the button 430 in the depressed state (releases the button), the navigation operation is terminated and the currently identified icon is selected. In other embodiments, the button may be embodied as a soft input, for example, at a touch-screen. In this latter embodiment, a tactile input to the touch screen activates the navigation mode. Navigation continues until the user removes the tactile input from the touch screen, at which time the operational indicator identified when the user removes the tactile input is selected.

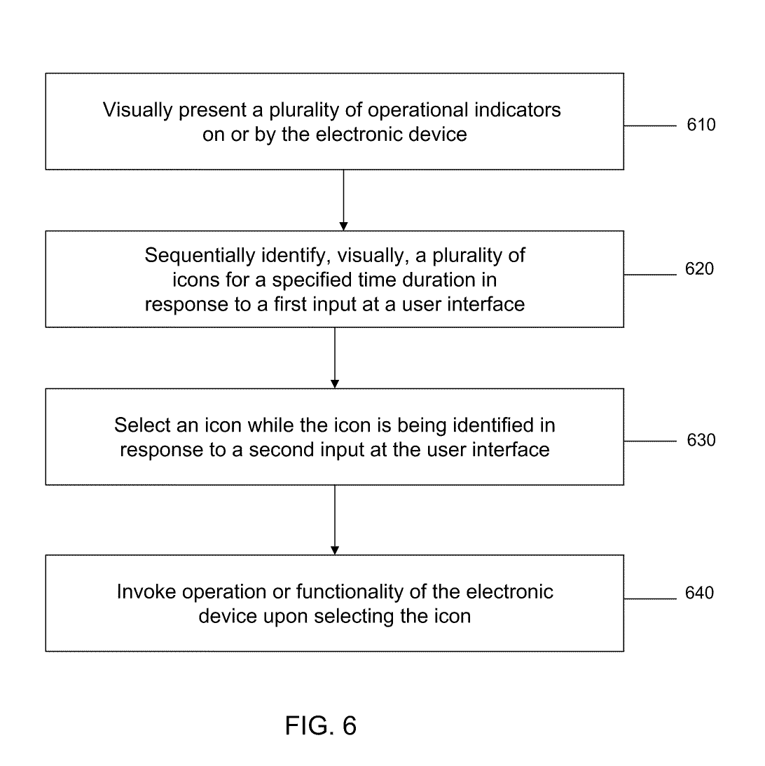

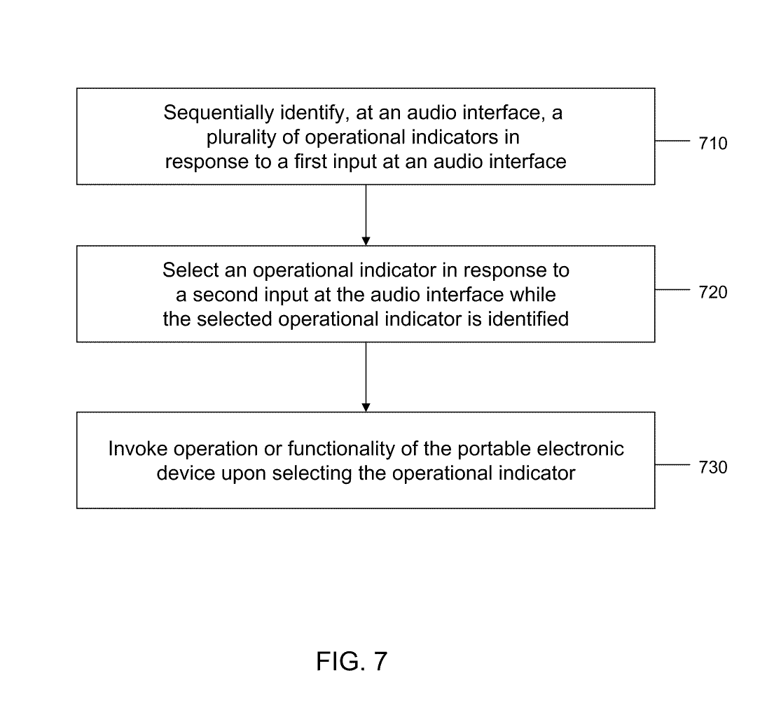

In the visual interface specific process flow diagram of FIG. 6, at 610, a plurality of icons are visually presented on or by the electronic device. For example, the icons may be presented on a display of the device or ported to an auxiliary display device or projected onto a display medium. At 620, the icons are sequentially identified at or on the display. In embodiments where the operational indicators are audible cues, the cues are presented by announcement at an audio interface of the electronic device or at an audio interface coupled to the device. In the audio interface specific process flow diagram of FIG. 7, the audible cues are sequentially identified as announced at 710.

Various different inputs of the user interface could be used to initiate the navigation mode. Regardless of whether the operational indicator is presented and/or identified as an audible cue or a visual icon, the initiation thereof may be made using a tactile input, an audible or voice input, a non-contact gesture input, or some other input. As suggested, in one embodiment, the navigation mode is initiated and terminated by related press and release actions, respectively. In an alternative embodiment, the termination mode is initiated and terminated by first and second distinct pressing or input actions, respectively. In either embodiment, the selection may occur concurrently with the action terminating navigation. Alternatively, selection may occur in response to some other input. As above, the selection input may be of the tactile, audible, gesture or other input type.

The operational indicators are generally identified at the user interface in a specified or particular order. For a specified set of operational indicators navigated, each operational indicator is identified on at least one occasion unless the navigation mode is terminated before then. Navigation mode may be terminated either manually or upon selection of an operational indicator. In some embodiments, navigation continues after selection. In some embodiments, the order or navigation sequence is repetitive. For example, upon initiation of the navigation mode, the operational indicators may be identified until the navigation mode is terminated. Also, the navigation order may be changed from time to time, either by the user or automatically, as discussed further below. In FIG. 3, the graphical icons are presented in a closed-circuit configuration, i.e., in a ring formation, and a visual icon indicator 320 sequentially identifies each icon by pointing to each icon for a specified time interval before pointing to an adjacent or neighboring icon. In other embodiments, the icons may be presented in some other visual format. For example, the presentation of the operational indicators may be arranged in an open-circuit configuration like a matrix array or the icons may be haphazardly dispersed about the display device.

Generally, the mechanism for identifying the icons may vary. In FIG. 3, a visual icon indicator 320 sequentially identifies each icon by pointing to each icon for a specified time interval before pointing to an adjacent or neighboring icon. In other embodiments, however, the icons may be sequentially identified by highlighting, changing color, magnifying, marking, e.g., by pop-up messages exhibited on the display, or by changing some other characteristic or attribute associated with the icon, for example, the size or orientation of the icon. The visual icons may also be sequentially identified through audio effects such as corresponding spatial sounds or voice-prompts. In embodiments where the operational indicators are audible cues, the audible cues are identified serially, such that only one audible cue is presented at a time. Thus the presentation and identification of operational identifiers, i.e., the audible cues, occurs simultaneously.

The presentation and identification of the operational indicators is performed or controller by the programmable processor under control of programmed instructions stored in memory, although this functionality may also be controlled by equivalent control hardware or a combination of hardware and software. In FIG. 1, the controller includes operational indicator presentation and identification functionality 152 that presents the operational indicators on the user interface and that sequentially identifies the operational indicators in response to one or more user prompts as discussed above. As suggested, in some embodiments, the presentation and identification of the operational indicators are performed separately and in other embodiments these acts occur simultaneously.

Generally an operational indicator may be selected during the interval during which it is identified, as illustrated in FIG. 2, at 220. In the visual interface specific process flow diagram of FIG. 6, at 620, an icon is selected during the temporal interval during which it is identified. In FIG. 3, for example, the “quiet mode” icon is identified by the visual icon indicator 320. The “quiet mode” icon may be selected by the user during this time period. Similarly, in the audio interface specific process flow diagram of FIG. 7, at 720, an audible cue selectable during the time period during which it is identified. In embodiments where operational indicators are embodied as audible cues, the selection window occurs after announcement of the audible cue and before the announcement of the next audible cue in the sequence.

The initiation of the functionality associated with the operational indicators is performed by the programmable processor under control of programmed instructions stored in memory, although this functionality may also be controlled by equivalent control hardware or a combination of hardware and software. In FIG. 1, the controller includes operational indicator selection functionality 154 for this purpose. Selection may be invoked or prompted by the user at an input at the user interface as described generally above. In FIG. 1, the selection may occur by an input performed at one of the sensors 135 as discussed further below. The input that terminates the navigation mode may be the same as or different than the input that invokes selection. In one embodiment, the selection of an operational indicator occurs upon terminating navigation. In FIG. 4, for example, the navigation mode is invoked upon depressing the push button 430 and navigation mode is maintained as long as the push button is depressed. According to this embodiment, when the user ceases to hold the button 430 in the depressed state or to otherwise apply some other input invoking navigation mode, as illustrated in FIG. 5, the navigation operation is terminated and the currently identified icon is selected. In FIG. 1, the input selecting the icon is detected by one or more sensors 135 and communicated to the controller 150 when the input ceases, for example, when an input key is released, or when the user removes a touch to a tactile interface, or when some other input is applied. In another embodiment, selection of an operational indicator terminates navigation. In still other embodiments, navigation continues or proceeds after selection. For example, the navigation may continue in the background or may run in another window after selection. Alternatively, the selected functionality may run in the background while the navigation proceeds on the main display, possibly permitting the user to make multiple selections.

Various different inputs of the user interface could be used to select an operational indictor. Regardless of whether the operational indicator is presented and/or identified as an audible cue or a visual icon, the selection thereof may be made using a tactile input, an audible or voice input, a non-contact or gesture type input, or some other input.

The selection of an operational indicator generally causes the invocation or initiation of some functionality or feature associated with the selected operational indicator. For example, a selection may launch an application or select a setting or navigate to another menu layer, etc. In FIG. 2, at 230, an operation or some feature or functionality of the electronic device is invoked upon selecting an operational identifier. In FIG. 6, at 640, an operation or some feature or functionality of the device is invoked upon selecting a visual icon at the user interface. Alternatively, such invocation occurs upon selecting an audible cue as indicated in FIG. 7 at 730.

In one embodiment, the navigation rate is varied based on a variable input at the user interface. The variation in the navigation rate is characterized by varying the rate at which the operational indicators are identified or navigated. Changing the rate at which the operational indicators are identified affects the time duration associated with the identification of each operational indicator. Particularly, increasing the navigation rate decreases the temporal duration or the window during which the identified operational indicator may be selected. Conversely, decreasing the navigation rate increases the window during which selection may occur.

In FIG. 1, the controller 150 includes navigation rate functionality that varies the rate of navigation based on the variable input detected. In a more particular implementation, the navigation rate is proportional to a variable input. In FIG. 1, the input device 134 is a variable input device having one or more sensors 135 capable of detecting or measuring a variable input. For example, a variable input can be based on a variable amount of force applied by a user to the user interface. In one embodiment, a harder press increases the rate of navigation while a softer press decreases the navigation rate. Alternatively, the variable input may be based on the rate at which the user swipes or drags along a tactile surface of the user interface. Similarly, the user may use a gesture without touching the user interface to change the rate. The variable input could also be multiple presses (e.g., within a time interval) to navigate at higher speed such as double speed, press three times triple speed, etc. Another example is to press multiple keys to move faster would occur by pressing a single key. In other embodiments, the navigation rated depends on the orientation of the device, as detected using an accelerometer. For example the navigation rate may be different if the device is oriented for landscape view than for portrait view. In another embodiment, the navigation rate depends on the number of cues navigated. For example, the navigation rate may be relatively fast where fewer cues are presented and relative slow for more cues. Another commonly used variable input sensor is a slider or some other sensor where the location of the finger along a pathway determines the magnitude of the input. Further examples of variable inputs for changing the navigation rate include, but are not limited to, variable amount of surface contact as detected by a resistive or capacitive sensor, varying movement and/or orientation of the device as detected by one or more motion sensors (such as accelerometers, gyroscopic sensors, compasses, and the like), and varying audio input detected by one or more audio sensors (such as voice commands). Varying the navigation rate may enable the user to quickly skip through or past operational indicators of less interest and to slow the navigation rate on or near indicators of greater interest. In an alternative implementation, the navigation rate is varied based on some other input. For example, the navigation rate may be based on a number of taps or based on a frequency of such inputs. Sensors suitable for detecting or measuring variable and non-variable inputs include, but are not limited to, capacitive sensors, resistive sensors, and magnetic sensors among others.

In another embodiment, the order in which the plurality of operational indicators is identified is changed in response to an input at the user interface. In one particular implementation, in FIG. 1, the input device 134 includes a directional input sensor for detecting change to the navigation order. More particularly, the controller 150 is configured to change the order in which operational indicators are identified based on the input sensed at the user input. In FIGS. 4 and 5, for example, the direction of the navigation is changed. Particularly, the icon indicator 420 may rotate in a clockwise direction or counter-clockwise direction, to sequentially identify the operation indictors, depending on a direction sensed at a directional input. The directional input may be embodied as a tactile touchpad, or toggle device, or a joystick, or up/down volume keys, or 5-way navigation key, or any other sensor which can distinguish between at least two unique user inputs or some other input. The change in the order of identifying the operational indicators need not be limited to clockwise counter-clockwise directional changes. In FIG. 3, for example, the icon indicator 320 may sequentially identify non-neighboring icons, for example, by navigating in a star-like pattern.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a portable electronic device including a user interface, the method comprising:
sequentially identifying, in a specified order, a plurality of operational indicators of the portable electronic device in response to a first input at the user interface,
the plurality of operational indicators identified at the user interface for a time interval during which an identified operational indicator may be selected;
selecting an operational indicator during the corresponding time interval in response to a second input at the user interface during a corresponding time interval; and
invoking an operation of the portable electronic device upon selecting the operational indicator.

2. The method of claim 1, varying a rate at which the plurality of operational indicators is sequentially identified in response to a variable input at the user interface.

3. The method of claim 1, changing the order in which the plurality of operational indicators is identified in response to an input at the user interface.

4. The method of claim 1,
the operational indicator is an application indicator associated with a corresponding application executable on the portable electronic device,
invoking the operation of the portable electronic device includes launching an application associated with the application indicator identified.

5. The method of claim 1,
visually presenting the plurality of operational indicators on a display of the portable electronic device,
sequentially identifying, on the display, the plurality of operational indicators of the portable electronic device in response to the first input at the user interface.

6. The method of claim 5, varying a rate at which the plurality of operational indicators are sequentially identified in response to a variable input at the user interface.

7. The method of claim 5 further comprising changing the order in which the plurality of operational indicators are identified in response to an input at the user interface.

8. The method of claim 1,
sequentially identifying the plurality of operational indicators of the portable electronic device in response to the first input at an audio user interface of the portable electronic device,
selecting the operational indicator in response to the second input at the audio user interface.

9. The method of claim 8 further comprising varying a rate at which the plurality of operational indicators are sequentially identified in response to a variable input at an audio user interface.

10. The method of claim 8 further comprising changing the order in which the plurality of operational indicators are identified in response to an input at the audio user interface.

11. A method in a portable electronic device, the method comprising:
presenting a plurality of objects on a user interface of the portable electronic device;
navigating continuously through the plurality of objects in response to a first user input;
receiving a second user input while navigating; and
activating an object in response to the second user input.

12. The method of claim 11 wherein, navigating the list of objects when a user action is initiated comprises:
detecting an input signal due to initiating the user action, and
navigating the list of objects based on the input signal.

13. The method of claim 11 further comprising navigating the plurality of objects in an order based on the first user input.

14. The method of claim 11 wherein the first user input is a variable input, further comprising navigating at a rate proportional to the variable input.

15. The method of claim 11, wherein navigating the plurality of objects includes providing a visual indication of a selection position while navigating from object to object.

16. The method of claim 11, wherein navigating the plurality of objects includes providing an audio indication of a selection position while navigating from object to object.

17. The method of claim 11, wherein activating an object comprises terminating the navigation of the list and invoking a function associated with the object.

18. A portable electronic device comprising:
a display having a plurality of visual cues, each visual cue associated with a corresponding application executable on the portable electronic device,
the display having a cue indicator visually associated with one of the plurality of visual cues, the visual cue associated with the cue indicator being selectable to launch the corresponding application;
a controller coupled to the display;
a user accessible input device coupled to the controller,
the controller configured to sequentially change, in a specified order, the visual cue with which the cue indicator is visually associated in response to a first input at the input device,
the controller configured to select a visual cue in response to a second input at the input device, the selected visual cue is the visual cue with which the cue indicator is currently associated upon the occurrence of the second input,
whereby the application associated with the selected visual cue is launched upon selecting the corresponding visual cue.

19. The device of claim 18,
the input device is a variable input detecting device,
the controller configured to vary the rate at which the visual cue, with which the cue indicator is associated, is sequentially changed based on an input to the variable input detecting device.

20. The device of claim 18,
the input device includes directional input sensor,
the controller configured to change the specified order in which visual cues associated with the cue indicator are sequentially changed based on an input to the directional input sensor.
